(19) United States
(12) Patent Application Publication
(10) Pub. No.: US 2014/0204594 A1
(43) Pub. Date: Jul. 24, 2014

(54) ILLUMINATION LIGHT SOURCE AND LIGHTING APPARATUS

(71) Applicant: PANASONIC CORPORATION, Osaka (JP)

(72) Inventors: Yukiya KANAZAWA, Osaka (JP); Katsushi SEKI, Shiga (JP); Youji TACHINO, Nara (JP); Toshio MORI, Hyogo (JP); Nozomu HASHIMOTO, Osaka (JP); Ryuya MIWA, Osaka (JP); Kayo NOJIRI, Osaka (JP)

(73) Assignee: PANASONIC CORPORATION, Osaka (JP)

(21) Appl. No.: 14/157,676

(22) Filed: Jan. 17, 2014

(30) Foreign Application Priority Data
Jan. 22, 2013 (JP) 2013-009627

(51) Int. Cl. F21V 21/30

(52) U.S. Cl. CPC F21V 21/30
USPC 362/362

(57) ABSTRACT

An illumination light source which attaches to a lighting fixture by being rotated in a predetermined rotational direction R, the illumination light source including: a light-emitting unit (LED module), a case which includes a first opening and houses the light-emitting unit; and a translucent cover provided over the first opening, wherein the translucent cover includes a plurality of projecting portions provided at predetermined intervals in the rotational direction R, and the plurality of projecting portions each include a plurality of projections provided at a predetermined distance from each other in the rotational direction R and including a flat surface facing a direction opposite the rotational direction R.

### CROSS REFERENCE TO RELATED APPLICATION

The present application is based on and claims priority of Japanese Patent Application No. 2013-009627 filed on Jan. 22, 2013. The entire disclosure of the above-identified application, including the specification, drawings and claims is incorporated herein by reference in its entirety.

### FIELD

The present invention relates to illumination light sources and lighting apparatuses, and specifically to a light-emitting diode (LED) unit, which is one example of an illumination light source using LEDs, and a lighting apparatus which is provided with the LED unit.

### BACKGROUND

Solid-state light-emitting elements such as LEDs show promise as light sources in various products as they are small, highly efficient, and have a long operating life. In particular, recent years have seen advancement in research and development of illumination light sources using LEDs.

For example, a low profile LED unit (LED lamp) has been proposed as an illumination light source for use in an LED lighting apparatus, such as a recessed light or a spot light (for example Patent Literature 1).

This type of LED unit has a GX53 base size and generally includes a flat disk-shaped or low profile case provided with an opening, an LED module housed inside the case, a translucent cover which covers the opening of the case, and lighting circuitry for lighting the LED module. The LED module is configured of, for example, a substrate and a plurality of LEDs mounted on the substrate.

This kind of low profile LED unit is, for example, attached to a lighting fixture recessed in a ceiling. The lighting fixture includes, for example, a reflector plate configured to surround the LED unit and a socket to which the base of the LED unit attaches.

### CITATION LIST

### Patent Literature

[PTL 1] WO 2012/005239

### Summary

### Technical Problem

However, in lighting fixtures used in lighting apparatuses such as recessed light, since the internal space of structures, such as a reflection plate, of that surround the LED unit is confined, attaching the LED unit to the lighting fixture is not simple.

In particular, there are lighting fixtures which provide little to no space between the inner surface of the reflection plate and the LED unit. When one tries to attach an LED unit to this kind of lighting fixture, his or her fingers cannot fit between the reflection plate and the LED unit, making it impossible to attach the LED unit to the lighting fixture while holding the side surface of the case with his or her fingers. This makes attaching the LED unit to the lighting fixture very difficult.

The present invention has been made in view of the above problem, and aims to provide an illumination light source and a lighting apparatus which allow for easy attachment to a lighting fixture.

### Solution to Problem

In order to achieve the above-described goal, the illumination light source according to the present invention is an illumination light source which attaches to a lighting fixture by being rotated in a predetermined rotational direction, the illumination light source including: a light-emitting unit; a case which includes an opening and houses the light-emitting unit; and a translucent cover provided over the opening, wherein the translucent cover includes a plurality of projecting portions provided at predetermined intervals in the rotational direction, and the plurality of projecting portions each include a plurality of projections provided at a predetermined distance from each other in the rotational direction and including a flat surface facing a direction opposite the rotational direction.

Moreover, according to an aspect of the illumination light source according to the present invention, the plurality of projecting portions may be provided at approximately equal intervals. In this case, for example, a total number of the plurality of projecting portions may be two or three.

Moreover, according to an aspect of the illumination light source according to the present invention, each of the plurality of projections may be a flat plate having two main surfaces on opposite sides thereof, one of the two main surfaces being the flat surface.

Moreover, according to an aspect of the illumination light source according to the present invention, the predetermined distance may be no less than 1 mm and no more than 3 mm.

Moreover, according to an aspect of the illumination light source according to the present invention, the translucent cover may include a flat surface portion whose normal line corresponds to a rotational axis of the illumination light source, a side surface portion provided around the flat surface portion, and a tapered portion provided between the flat surface portion and the side surface portion, the plurality of projecting portions may be provided on the tapered portion, and a plurality of ribs may be provided on the tapered portion between the plurality of projecting portions.

In this case, the plurality of ribs may also be formed on the side surface portion.

Furthermore, the plurality of projections may have a ridge line in a radial direction of rotation which is inclined toward the side surface portion with respect to the flat surface portion.

Moreover, an aspect of the lighting apparatus according to the present invention includes any one of the above described illumination light sources; and the lighting fixture with the illumination light source attached thereto.

### Advantageous Effects

The present invention allows for easy attachment of the illumination light source to a lighting fixture.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1A is a perspective view from above of the LED unit according to the embodiment of the present invention.

FIG. 1B is a perspective view from below of the LED unit according to the embodiment of the present invention.

FIG. 2 is an exploded perspective view of the LED unit according to the embodiment of the present invention.

FIG. 3 (a) in FIG. 3 shows a planar view of the LED unit according to the embodiment of the present invention, (b) in FIG. 3 shows a side view of the same LED unit, and (c) in FIG. 3 shows a cross sectional view of the same LED unit at the line A-A′ shown in (a) in FIG. 3.

FIG. 4 is an expanded view of a relevant portion of the translucent cover of the LED unit according to the embodiment of the present invention.

FIG. 5 is an expanded view of a portion of the translucent cover of the LED unit according to the embodiment of the present invention.

FIG. 6 is a cross sectional view showing the configuration of the lighting apparatus according to the embodiment of the present invention.

FIG. 7 shows how the LED unit according to the embodiment of the present invention attaches to the lighting fixture.

FIG. 8 shows procedures for attaching the LED unit according to the embodiment of the present invention to the lighting fixture.

FIG. 9 is an external perspective view of the LED unit according to Variation 1 of the present invention.

FIG. 10 is an external perspective view of the LED unit according to Variation 2 of the present invention.

FIG. 11A is cross section of Variation 1 of the projecting portions of the LED unit according to the embodiment of the present invention.

FIG. 11B is cross section of Variation 2 of the projecting portions of the LED unit according to the embodiment of the present invention.

FIG. 11C is cross section of Variation 3 of the projecting portions of the LED unit according to the embodiment of the present invention.

### DESCRIPTION OF EMBODIMENT

Hereinafter, the illumination light source and the lighting apparatus according to the embodiment of the present invention are described with reference to the drawings. It should be noted the embodiment described below shows a specific example of the present invention. The numerical values, shapes, materials, structural elements, the arrangement and connection of the structural elements etc. shown in the following embodiment are mere examples, and therefore do not limit the present invention. Therefore, among the structural elements in the following embodiment, structural elements not recited in any one of the independent claims defining the most generic part of the inventive concept are described as arbitrary structural elements.

In the embodiment, an LED unit (LED lamp) will be described as an example of the illumination light source. It should be noted that the Drawings are schematic drawings, and are not necessarily exact depictions. Moreover, in the Drawings, elements having the same essential configuration share the same reference numerals. Duplicate explanations of these elements are omitted or condensed.

### (LED Unit)

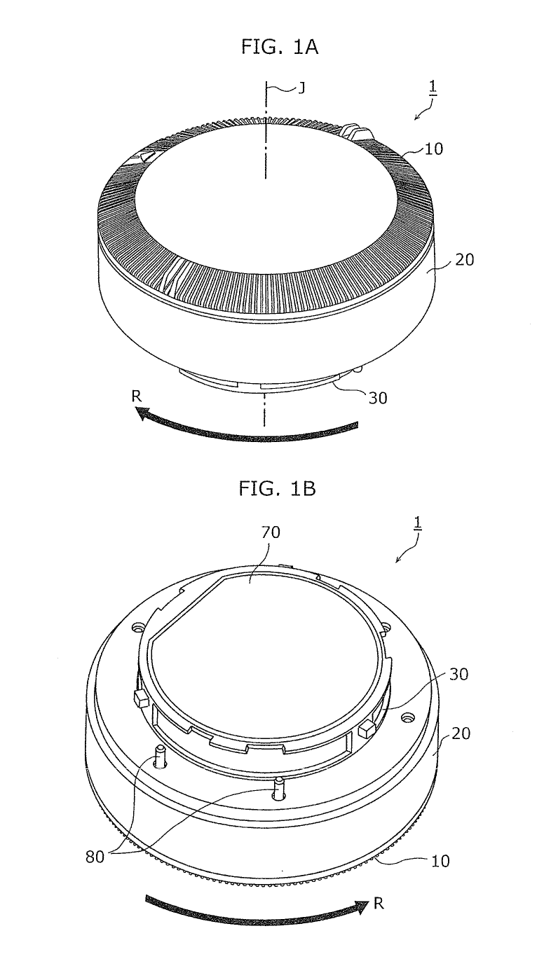

First, the framework of the LED unit 1 according to the embodiment of the present invention will be described with reference to FIG. 1A and FIG. 1B. FIG. 1A is a perspective view from above of the LED unit according to the embodiment of the present invention, and FIG. 1B is a perspective view from below of the same LED unit.

It should be noted that in FIG. 1A, the dotted and dashed line represents a lamp axis J of the LED unit 1. In the embodiment, the lamp axis (unit axis) J is the rotational center (rotational axis) when the LED unit 1 is rotated upon attachment to the socket of the lighting fixture. The lamp axis J corresponds with the center axis of the base of the LED unit 1 and the center axis of the socket in the lighting fixture. In the embodiment, the lamp axis J also corresponds with the center axis of a translucent cover 10 which is circular in shape in a planar view.

As FIG. 1A and FIG. 1B show, the LED unit 1 according to the embodiment is a low profile LED unit having an overall flat disk shape or low profile shape, and is peripherally configured of a translucent cover 10, a case 20, and a support base 30. A GX35 or GH76p base, for example, is used for the base of the LED unit 1.

The LED unit 1 attaches to a lighting fixture by being rotated in a predetermined rotational direction, as will be described later. In the embodiment, the term predetermined rotational direction refers to the direction of the rotation of the LED unit 1 when it is rotated about the lamp axis J as an axis of rotation. For example, as FIG. 1A and FIG. 1B show, the LED unit 1 is attached to the lighting fixture by rotating the LED unit 1 about the lamp axis J in the rotational direction R. Additionally, the LED unit 1 is detached from the lighting fixture by rotating the LED unit 1 about the lamp axis J in a direction opposite the rotational direction R.

It should be noted that in the embodiment, the light emission side is the side from which light is emitted, and, with reference to the LED unit 1, is the side from which light is guided out of the LED unit 1 (light guided side). In FIG. 1A, the light emission side is on top, and in FIG. 1B, the light emission side is on bottom.

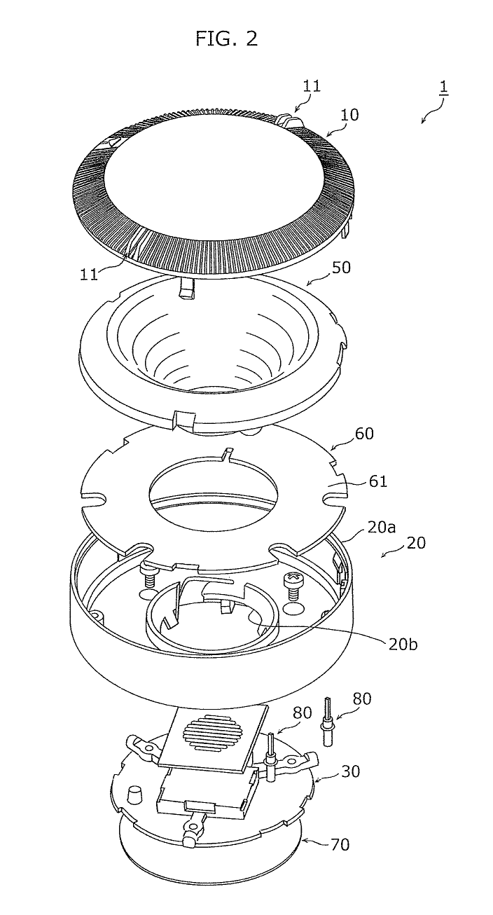

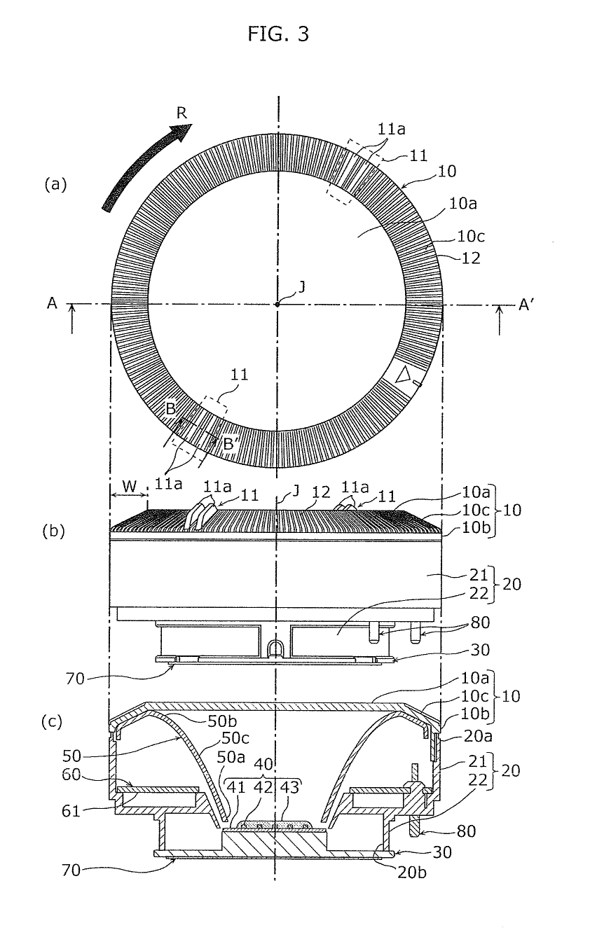

Next, the configuration of the LED unit 1 according to the embodiment will be described in detail with reference to FIG. 2 and FIG. 3. FIG. 2 is an exploded perspective view of the LED unit according to the embodiment of the present invention. Additionally, (a) in FIG. 3 shows a planar view of the LED unit, (b) in FIG. 3 shows a side view of the LED unit, and (c) in FIG. 3 shows a cross sectional view of the LED unit at the line A-A′ shown in (a) in FIG. 3.

As FIG. 2 and FIG. 3 show, the LED unit 1 according to the embodiment includes the translucent cover 10, the case 20, the support base 30, an LED module 40, a reflection plate 50, driving circuitry 60, a heat transfer sheet 70, and connecting pins 80.

The translucent cover 10 is made of a translucent material to guide light emitted from the LED module 40 outside the lamp, and is for example made using a resin material such as acryl (PMMA) or polycarbonate (PC). The translucent cover 10 may be a structure which diffuses light, or may be a structure which does not diffuse light. For example, the translucent cover 10 can be configured to have light diffusion properties by forming a white light diffusing film by coating the inner surface of the translucent cover 10 with a white pigment or resin containing a light diffusing material such as silica or calcium carbonate, or forming minute indentations in the translucent cover 10.

Moreover, the translucent cover 10 is provided over a first opening 20a of the case 20 The translucent cover 10 according to the embodiment is fixed to the case 20 so as to cover the first opening 20a to protect the LED module 40 and the driving circuitry 60 provided in the case 20. It should be noted that a detailed description of the configuration of the translucent cover 10 will be given later.

The case 20 is a low profile cylindrical component which houses the LED module 40, and as FIG. 2 and (c) in FIG. 3 show, includes the first opening 20a formed on the light emission side of the case 20 and a second opening 20b formed on the side opposite the light emission side of the case 20. It should be noted that the reflection plate 50 and the driving circuitry 60 are also housed in the case 20.

The case 20 according to the embodiment is configured of a large diameter portion 21 made of a thin cylindrical component large in diameter, and a small diameter portion 22 made of a thin cylindrical component small in diameter. The small diameter portion 22 projects from the bottom surface of the large diameter portion 21 toward the side opposite the light emission side. It should be noted that the first opening 20a is formed on the large diameter portion 21, and the second opening 20b is formed on the small diameter portion 22.

As (c) in FIG. 3 shows, the translucent cover 10 is attached to the first opening 20a of the case 20 (large diameter portion 21). The case 20 is fastened to the support base 30 with, for example, three screws. The case 20 is made of a resin having insulating properties, such as polybutylene terephthalate (PBT). It should be noted that the case 20 is not required to be made from resin, and may be made from metal.

The support base 30 is a supporting member which supports the LED module 40 and the case 20. Moreover, the support base 30 also functions as a heat sink for the heat generated by the LED module 40. As such, the support base 30 may be made of metal such as aluminum or a resin having a high rate of heat transfer. As (c) in FIG. 3 shows, the support base 30 is arranged to cover the second opening 20b of the case 20 (small diameter portion 22).

Moreover, the support base 30 is connected to the lighting fixture via the heat transfer sheet 70. The support base 30 functions as a given base which connects to the lighting fixture as well as the case 20 and the connecting pins 80. The LED unit 1 according to the embodiment has a standard base size which corresponds with the socket of the lighting fixture. Examples include a GX35 base or a GH76p base, as described above.

The LED module 40 is the light source in the LED unit 1 and emits light of a predetermined color (wavelength), such as a white light. As (c) in FIG. 3 shows, the LED module 40 is placed on and fixed to the support base 30. The LED module 40 can be fixed to the support base 30 by, for example, applying an adhesive agent between a substrate 41 and the support base 30.

The LED module 40 emits light using power supplied from the driving circuitry 60. The light radiated from the LED module 40 passes through the translucent cover 10 and is emitted out of the lamp.

As (c) in FIG. 3 shows, the LED module 40 can be configured of the substrate 41, an LED 42, and a sealing component 43, for example. The light-emitting unit is configured of the LED 42 and the sealing component 43.

The LED module 40 according to the embodiment has a chip on board (COB) type structure in which a bare chip (LED 42) is mounted directly on the substrate 41. Although not shown in the drawings, it should be noted that metal wiring of a predetermined shape for electrically connecting the LEDs 42 together and terminals which receive power for causing the LEDs 42 to emit light, for example, are provided on the substrate 41.

A ceramic substrate, resin substrate, or a metal based substrate may be used as the substrate 41. Regarding the shape of the substrate 41, as FIG. 2 shows, a substrate that is rectangular in a planar view can be used, but a substrate that is polygonal such as a hexagonal or octagonal substrate, or a round substrate may be used as well.

The LEDs 42 are one example of a light-emitting element, and are semiconductor light-emitting elements which emit light using a predetermined power. The LEDs 42 according to the embodiment are bare chips which emit a monochromatic visible light. For example, a blue LED chip which emits a blue light when power passes through it can be used as the LED 42. A plurality of the LEDs 42 are mounted in a plurality or rows or a matrix on the main surface of the substrate 41, for example.

The sealing component 43 is made from, for example, resin, and is formed to seal the plurality of LEDs 42 collectively. In this case, as FIG. 2 shows, the sealing component 43 may be formed in individual line shapes, each of which covers a row of the LEDs 42 collectively, or alternatively, may be formed in a circular or rectangular shape in a planar view to cover all of the LEDs 42 on the substrate 41 collectively.

The sealing component 43 is mainly made from a translucent material, but when it is necessary to convert the wavelength of the light from the LEDs 42 into a predetermined wavelength, a wavelength converting material is mixed into the translucent material. The sealing component 43 according to the embodiment includes a phosphor as the wavelength converting material, and is a wavelength converting member which converts the wavelength (color) of the light emitted from the LEDs 42. This kind of sealing component 43 can be configured from a resin material having insulating properties and including phosphor particles as the phosphor (phosphor-containing resin). The phosphor particles are excited by the light emitted from the LEDs 42 and radiate light of a desired color (wavelength).

Silicon resin, for example, can be used as the translucent resin material for the sealing component 43. Moreover, when, for example, blue LEDs which emit a blue light are used as the LEDs 42, YAG yellow phosphor particles, for example, can be used as the phosphor particles contained in the sealing component 43 in order to yield a white light. With this, a portion of the blue light emitted from the LEDs 42 is wavelength-transformed into a yellow light by the yellow phosphor particles included in the sealing component. Then, the blue light not absorbed by the yellow phosphor particles mixes with the yellow light resulting from the wavelength-transformation by the yellow phosphor particles so that the light emitted from the sealing component 43 is white. In other words, the region in which the sealing component 43 is formed is a light-emitting region.

As (c) in FIG. 3 shows, the reflection plate 50 (reflecting mirror) is positioned between the translucent cover 10 and the LED module 40. The reflection plate 50 is a reflection member having reflective properties, and includes an entrance opening (first opening) 50a through which light from the LED module 40 enters and an exit opening (second opening) 50b through which light coming through the entrance opening 50a exits from the reflection plate 50. The reflection plate 50 according to the embodiment is configured to have a diameter that gradually increases from the entrance opening 50a toward the exit opening 50b. More specifically, the reflection plate 50 is trumpet (funnel) shaped.

The entrance opening 50a is configured to surround the light emission region of the LED module 40 (the region in which the sealing component 43 is formed). Moreover, the surface area of the exit opening 50b is approximately the same as the surface area of a flat surface portion 10a of the translucent cover 10.

The inner surface of the reflection plate 50 is a reflective surface 50c which reflects the light from the LED module 40. The reflective surface 50c is configured to reflect light entering from the entrance opening 50a and emit the light out from the exit opening 50b. The light from the LED module 40 is guided to the translucent cover 10 by the reflection plate 50.

The reflection plate 50 can be configured of a hard white resin material having insulating properties, for example. It should be noted that in order to increase reflectivity, the reflective surface 50c may be coated on the inner surface of the resin reflection plate 50 as a metal deposition film (metal reflective film) made from a metallic material such as silver or aluminum. Moreover, without using a resin material, the reflection plate 50 may be entirely made from a metallic material such as aluminum.

The driving circuitry 60 is power circuitry for lighting the LED module 40 (LEDs 42), and supplies a predetermined power to the LED module 40. For example, the driving circuitry 60 includes lighting circuitry which converts AC power (for example, power from an AC 100V industrial power supply) supplied from the connecting pins 80 into DC power, and supplies the converted DC power to the LED module 40. It should be noted that the power supplied to the driving circuitry 60 may be DC power instead of AC power.

The driving circuitry 60 includes a circuitry substrate 61 and a plurality of circuitry elements (not shown in the Drawings) mounted on the circuitry substrate 61.

The circuitry substrate 61 is a print substrate on which metal lines are patterned. The circuitry substrate 61 according to the embodiment is a ring shaped (donut shaped) substrate having a circular opening, and is arranged inside the case 20, outside the reflection plate 50.

Examples of the circuitry elements include semiconductor elements such as capacitive elements like electrolytic and ceramic capacitors, resistors, inductors, chokes (choke transformers), noise filters, diodes, and integrated circuit elements. The majority of the circuitry elements are mounted on the main surface on the light emission side of the circuitry substrate 61.

The driving circuitry 60 configured in this way is housed in the case 20, and for example, is secured in the case 20 by the circuitry substrate 61 and the case 20 being fastened together. It should be noted that when the case 20 is made of metal, it is preferable that the driving circuitry 60 be housed inside a circuitry case having insulating properties. Moreover, in addition to the lighting circuitry, light adjusting circuitry, vasopressure circuitry or other control circuitry may be selected as needed and paired with the driving circuitry 60.

The thermal transfer sheet 70 assists in letting heat from the LED module 40 transferred via the support base 30 escape to the lighting fixture. More specifically, the thermal transfer sheet 70 is a resin sheet having a high rate of heat transfer, and can be a silicon sheet or an acryl sheet.

The connecting pins 80 (base pins) are conductive pins and have a function of receiving electricity from outside the lamp in order to light up the LED module 40 (LEDs 42). In other words, the connecting pins 80 are power supply electrical connecting pins.

For example, a predetermined AC power is received from the lighting fixture by a pair of the connecting pins 80. Each connecting pin 80 is connected to the circuitry substrate 61 with a lead wire (not shown in the Drawings), and the AC power received by the pair of connecting pins 80 is supplied to the driving circuitry 60 with the lead wires. It should be noted that in the embodiment, the pair of connecting pins 80 receive AC power, but they may be configured to receive two different types of DC power.

Moreover, the connecting pins 80 also function as attachment portions for attaching the LED unit 1 to the lighting fixture. More specifically, the LED unit 1 is secured to the lighting fixture as a result of the connecting pins 80 connecting to the socket of the lighting fixture.

The connecting pins 80 are configured to project out from the bottom surface of the case 20 (large diameter portion 21). The connecting pins 80 are, for example, pressed into place in through holes provided in the large diameter portion 21 of the case 20.

In the embodiment, two connecting pins 80 are provided for supplying power, but in addition to connecting pins for supplying power, signal electrical connecting pins for receiving electric signals such as light adjustment signals or connecting pins having other functions may also be provided. These plurality of connecting pins are provided having rotational symmetry about the lamp axis J on the bottom surface portion provided on the large diameter portion 21, for example.

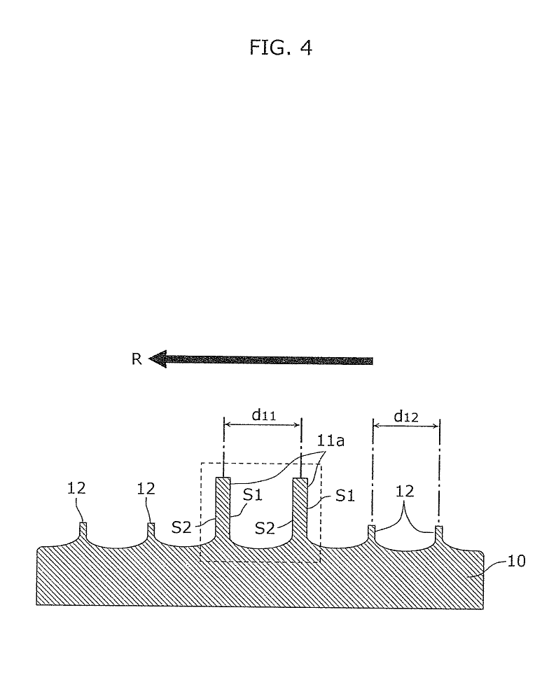

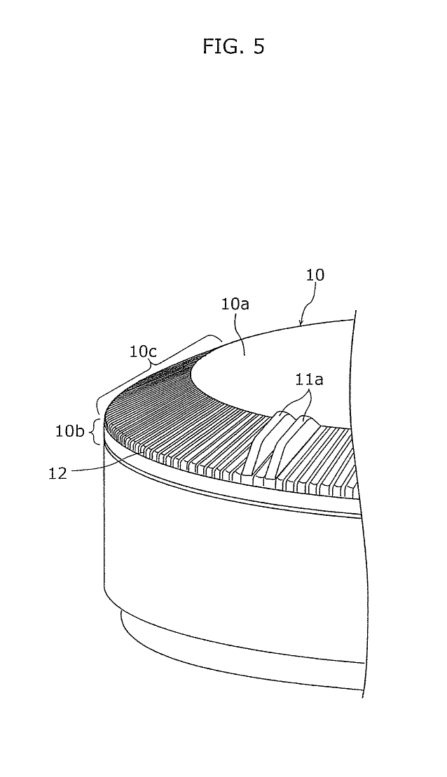

Next, the configuration of the translucent cover 10 according to the embodiment will be described in detail using FIG. 4 and FIG. 5 in reference to FIG. 2 and FIG. 3. FIG. 4 is a cross sectional expanded view of the relevant part of the translucent cover of the LED unit according to the embodiment of the present invention, and shows a cross section of the translucent cover along the line B-B′ shown in (a) in FIG. 3. FIG. 5 is an expanded view of a portion of the translucent cover of the LED unit according to the embodiment of the present invention.

As FIG. 2 and FIG. 3 show, the translucent cover 10 is provided with a plurality of projecting portions 11. The plurality of projecting portions 11 (first projecting portions) are provided at predetermined intervals in the rotational direction R (see FIG. 3) of the LED unit 1 when being attached to the lighting fixture. In other words, the plurality of projecting portions 11 are provided on the same circle. For example, it is possible to provide two projecting portions 11 across from each other relative to the lamp axis J. In the embodiment, two projecting portions 11 are provided at equal intervals (in other words at 180° intervals) along the perimeter of the translucent cover 10 having a circular shape in a planar view.

It should be noted that, taking into consideration holdability when attaching the LED unit 1 to the lighting fixture, the two projecting portions 11 provided at 180° intervals may be positioned within a ±30° range based on the 180° interval positions.

Each of the projecting portions 11 are formed having projecting and recessed portions, and includes a plurality of projections 11a provided at predetermined intervals in the rotational direction R. As FIG. 4 shows, the projecting portions 11 according to the embodiment are configured of two projections 11a.

Each of the two projections 11 has a flat surface S1 which faces a direction opposite the rotational direction R. For example, the flat surface S1 is configured so that the normal line of the flat surface S1 substantially corresponds to the rotational direction R. Moreover, each of the projections 11a according to the embodiment are configured of a flat plate, the main surfaces of which are the flat surface S1 and a flat surface S2 on an opposite side of the flat surface S1. In other words, as (a) in FIG. 3 and FIG. 4 show, each of the projecting portions 11 includes two flat plate shaped projections 11a lined up to face each other and vertically provided to extend length-wise in the radial direction of the rotational radius when the LED unit 1 is rotated (the radial direction of the circular flat surface portion 10a). As FIG. 4 shows, in the embodiment, the two projections 11a of each of the projecting portions 11 are provided spaced apart by a distance d11 in the rotational direction R. The distance d11 can be, for example, 2 mm.

Moreover, as FIG. 3 shows, the translucent cover 10 according to the embodiment includes a flat surface portion 10a, a side surface portion 10b, and a tapered portion 10c.

In a planar view, the flat surface portion 10a is circular in shape and the outer surface and inner surface of the flat surface portion 10a are flat surfaces whose normal line corresponds to the lamp axis J of the LED unit 1. In the embodiment, since the surface area of the flat surface portion 10a and the surface area of the opening of the exit opening 50b of the reflection plate 50 are approximately equal, the flat surface portion 10a is a light transmission region. In other words, in the embodiment, the light from the LED module 40 only exits from the flat surface portion 10a.

The side surface portion 10b has a thin cylindrical shape and is provided at the perimeter of the flat surface portion 10a. The outer surface of the side surface portion 10b is formed to be flush with the outer surface of the side surface portion of the case 20. The side surface portion 10b along with the side surface portion of the case 20 form the side surface portion of the LED unit 1.

The tapered portion 10c has a ring shape in a planar view and is provided between the flat surface portion 10a and the side surface portion 10b. The tapered portion 10c is configured to connect the circular outer periphery portion of the flat surface portion 10a and the top end of the ring shaped side surface portion 10b. The tapered portion 10c is configured to incline from the flat surface portion 10a to the side surface portion 10b toward the case 20, and has a predetermined taper angle (incline angle) with respect to the flat surface portion 10a. The tapered portion 10c is configured to incline about the lamp axis 3, and the taper angle at a given point in the circumferential direction of the tapered portion 10c is a constant angle relative to the lamp axis J.

In the embodiment, two projecting portions 11 are provided on the tapered portion 10c. Moreover, the top surfaces of the projections 11a of the projecting portions 11 also incline in accordance with the incline of the tapered portion 10c. In other words, the projections 11a are configured so that the ridge lines of the projections 11 in the radial direction of the rotational radius (in the embodiment, the top surfaces of the vertical flat plates) incline toward the side surface portion 10b relative to the flat surface portion 10a. Moreover, in the embodiment, the incline angle of the top surfaces of the projections 11a and the incline angle of the tapered portion 10c are approximately equal.

Moreover, as FIG. 3 shows, the tapered portion 10c is provided with a plurality of ribs 12. The ribs 12 (the second projecting portions) are provided in plurality continuously on the tapered portion 10c between two projecting portions 11. For example, the plurality of ribs 12 are formed to line up on the tapered portion 10c along the rotational direction R and extend in the radial direction of the rotational radius when the LED unit 1 is rotated. In other words, the plurality of ribs 12 are provided radiating out in the radial direction of the rotational radius about the lamp axis J. It should be noted that, as FIG. 4 shows, the distance d12 between two neighboring ribs 12 can be for, example, 2 mm.

As FIG. 5 shows, the ribs 12 according to the embodiment are formed not only on the tapered portion 10c but on the side surface portion 10b as well. In other words, each of the plurality of ribs 12 is formed continuously from the tapered portion 10c to the side surface portion 10b.

### (Lighting Apparatus)

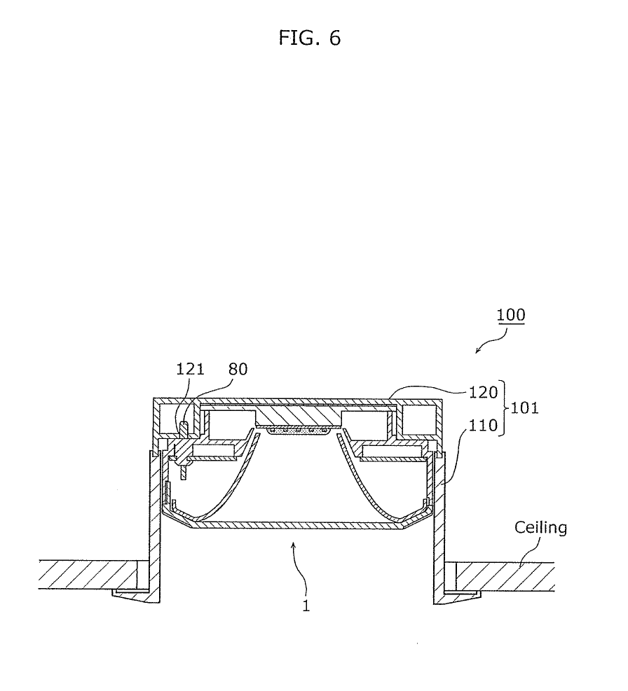

Next, the lighting apparatus 100 according to the embodiment of the present invention will be described using FIG. 6. FIG. 6 is a cross sectional view showing the configuration of the lighting apparatus according to the embodiment of the present invention.

As FIG. 6 shows, the lighting apparatus 100 according to the embodiment is, for example, a recessed light, and includes a lighting fixture 101 and the LED unit 1 according to the embodiment. The lighting fixture 101 includes a reflection plate 110 and a socket 120.

The reflection plate 110 is substantially cup shaped and has a circular opening, for example, and is configured to laterally surround the LED unit 1. The reflection plate 110 according to the embodiment is a cylindrical component having a substantially uniform inner diameter and is configured to have an inner surface which reflects the light from the LED unit 1. The reflection plate 110 can be configured of a white composite resin having insulating properties, for example. The inner surface of the reflection plate 110 may be coated with a reflective film to increase reflectivity.

It should be noted that the reflection plate 110 is not limited to a resin material; a metal reflection plate 110 formed by pressing a metal plate may be used. Moreover, the reflection plate 110 is not limited to a uniform inner diameter, and may be configured to have an inner diameter that gradually increases toward the light irradiated area (downward direction in the Drawings).

The socket 120 may be configured to accommodate a light base such as a GX35 base or a GH76p base, and configured to attach with the base of the LED unit 1. As a result of the LED unit 1 being attached to the socket 120, a predetermined power is supplied to the LED unit 1. The LED unit 1 is detachably attachable to the socket 120.

Moreover, the socket 120 is provided with a plurality of connecting holes 121 corresponding to the plurality of connecting pins 80. The connecting holes 121 are configured so that the connecting pins 80 can be inserted therein and are configured to hold the connecting pins 80. Structures that hold the connecting pins 80 that can be used include, for example, plate springs.

### (LED Unit Attachment Method)

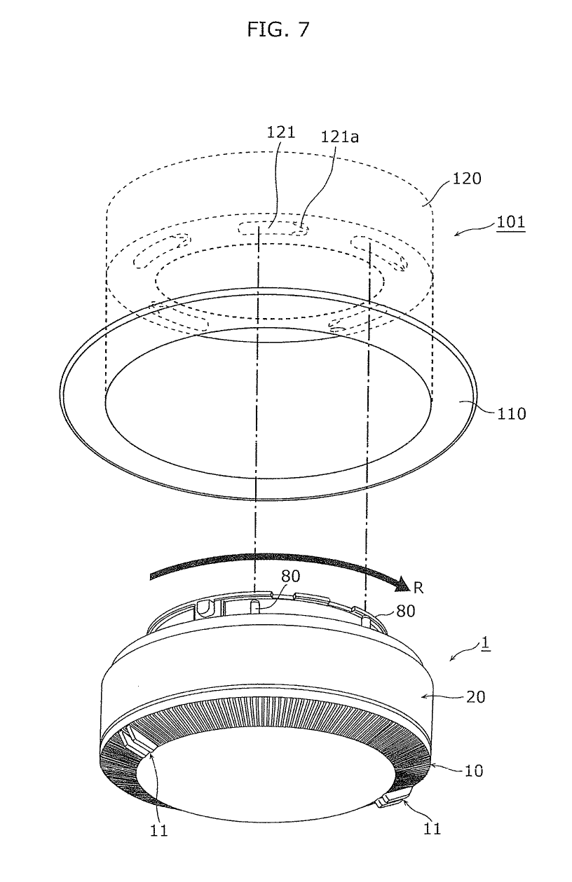

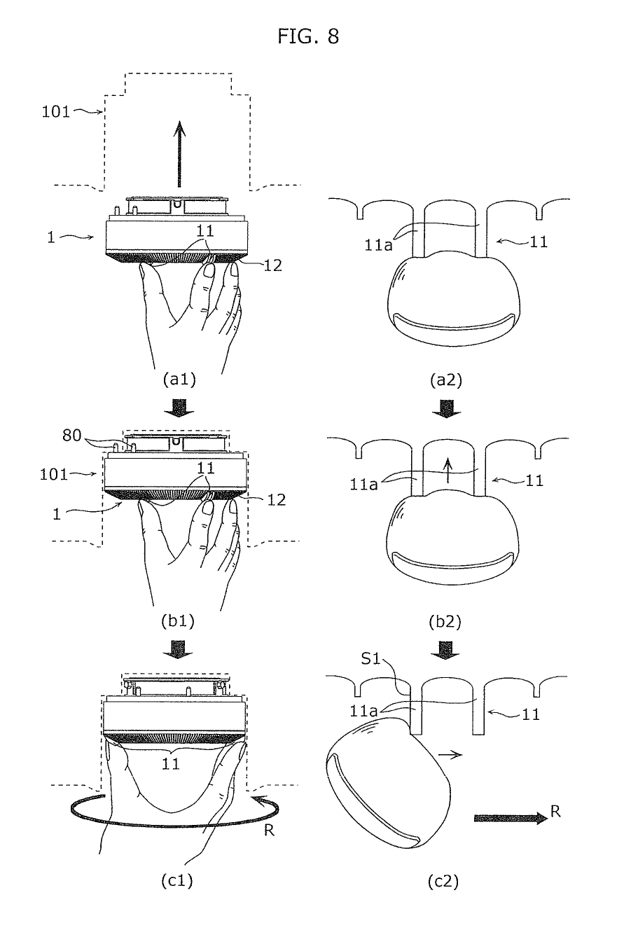

Next, the method of attaching the LED unit 1 to the lighting fixture 101 will be described using FIG. 7 and FIG. 8. FIG. 7 shows how the LED unit according to the embodiment of the present invention attaches to the lighting fixture. FIG. 8 shows procedures for attaching the LED unit according to the embodiment of the present invention to the lighting fixture.

As FIG. 7 shows, each of the connecting holes 121 of the socket 120 is long, narrow and curved along the rotational direction R. Moreover, a spring component 121a for holding a corresponding one of the connecting pins 80 is provided at one end in the lengthwise direction of each of the connecting holes 121. In addition to holding the connecting pins 80, the spring components 121a also function to supply power to the connecting pins 80.

When attaching the LED unit 1 to the lighting fixture 101, the connecting pins 80 of the LED unit 1 are inserted into the connecting holes 121, then using the projecting portions 11 the LED unit 1 is rotated in the rotational direction R at a predetermined angle (for example, approximately a 10 degree angle) to move the connecting pins 80 to the spring components 121a. At this time, since the connecting pins 80 are pushed against by the pushing force of the spring components 121a, the connecting pins 80 receive the spring elastic force (restoring force) of the spring components 121a. With this, the LED unit 1 is held in the socket 120 and power can be supplied to the LED unit 1.

Next, the procedure of attaching the LED unit 1 according to the embodiment to the lighting fixture 101 will be described in detail using FIG. 8. It should be noted that in FIG. 8, the depictions on the left side show the LED unit 1 when it is supported by a hand, and the depictions on the right side show the relationship between the finger and the projecting portions 11 at the time of the corresponding left side depiction.

First, as (a1) in FIG. 8 shows, the LED unit 1 is held in hand while two fingers (digits) are placed on the projecting portions 11 and lifted toward the lighting fixture 101. For example, the LED unit 1 is held in hand by placing the pad of the thumb on one of the projecting portions 11 and placing the pad of the index finger on the other of the projecting portions 11, and in this state, the LED unit 1 is lifted toward the lighting fixture 101.

In this case, as (a2) in FIG. 8 shows, for each of the thumb and the index finger, two of the projections 11a are in contact with the pads thereof. With this, the LED unit 1 can be held stably and level. In other words, even if the projecting portions 11 are provided in a plurality of positions, if each of the projecting portions 11 is only provided with one projection 11a, holding the LED unit 1 stably and level is difficult.

Moreover, in the embodiment, as described above, since the ridge line of the projections 11a inclines with respect to the flat surface portion 10a, it is possible to grip the LED unit 1 by squeezing the two projecting portions 11 with the thumb and index finger. In other words, it is possible to grip the LED unit 1 by applying pressure to the LED unit 1 with the thumb and index finger, not just rest the LED unit 1 on the thumb and index finger. With this, the LED unit 1 can be held even more stably.

Moreover, it is preferable that the LED unit 1s supported with other fingers as well, such as the middle finger, as (a1) in FIG. 8 shows. For example, it is possible to support the LED unit 1 by placing the middle finger on the ribs 12. With this, since the LED unit 1 can be supported using three fingers (at three positions) the LED unit 1 can be held even more stably.

Next, after the LED unit 1 is lifted upward, as (b1) in FIG. 8 shows, pushing force is applied to the LED unit 1 in a vertical direction from the bottom upward so that the base of the LED unit 1 is pushed into the socket of the lighting fixture 101. At this time, the LED unit 1 is pushed into the socket so that the connecting pins 80 of the LED unit 1 are inserted into the connecting holes 121 of the socket 120.

In this case, as (b2) in FIG. 8 shows, the thumb and index finger apply pushing force to the projecting portions 11 so that part of the finger pad goes in the area between the projections 11a. With this, it is possible to apply pushing force in the vertical direction in a stable manner.

Next, as (c1) in FIG. 8 shows, while pushing force is being applied from the bottom up, the LED unit 1 is rotated in the rotational direction R, and as FIG. 7 shows, the LED unit 1 is moved so that the connecting pins 80 are pressed in to the spring components 121a.

At this time, since the connecting pins 80 are pressed in to the spring components 121a against the pressing force of the spring components 121a, force for pushing the connecting pins 80 into the spring components 121a in the rotational direction R is necessary.

In the embodiment, since the projections 11a are provided with a flat surface S1 which faces a direction opposite the rotational direction R, when rotating the LED unit 1, it is possible to for the pad of a finger to catch on one of the projections 11a as (c2) in FIG. 8 shows. More specifically, it is possible for the pad of the thumb to catch on one projection 11a in one projecting portion 11, and for the pad of the index finger to catch on one projection 11a in another projecting portion 11. This makes the LED unit 1 easy to turn, so force can easily be applied in the rotational direction R. As such, the connecting pins 80 can easily be put into the spring components 121a.

Moreover, in the embodiment, since the middle finger is placed on the ribs 12, it is possible to use the middle finger catching on the ribs 12 when rotating the LED unit 1. This makes it even easier to apply force in the rotational direction R.

In this way, it is possible to attach the base of the LED unit 1 to the socket 120 of the lighting fixture 101. With this, the LED unit 1 is held in the lighting fixture 101.

With the LED unit 1 according to the embodiment, a plurality of the projecting portions 11 are provided on the translucent cover 10, and each of the plurality of projecting portions 11 includes a plurality of projections 11a. With this, it is possible to increase the holding stability when holding the LED unit 1 with a plurality of fingers. As such, since the LED unit 1 can easily be held level, it is possible to reduce the occurrences of the LED unit 1 dropping when attaching the LED unit 1 to the lighting fixture 101.

Furthermore, the projections 11a in each of the projections 11 have a flat surface S1 which faces a direction opposite the rotational direction R. With this, since it is possible for the pad of a finger to catch against the projection 11a when rotating the LED unit 1, it is possible to easily apply force when rotating the LED unit 1.

In this way, the LED unit 1 according to the embodiment is easy to hold level and turn, thereby making it easy to attach to the lighting fixture 101. Moreover, since the LED unit 1 according to the embodiment can be attached to the lighting fixture 101 without holding the side surface of the case 20, it is possible to easily attach and install the LED unit 1 to the lighting fixture 101 even when there is not enough room to insert a finger between the reflection plate 110 and the side surface of the LED unit 1 (case 20), as the case in FIG. 6.

Furthermore, the translucent covers 10 of two LED units 1 can be butted against each other so that the projecting portions 11 (projecting and receded portions) of one LED unit 1 and the projecting portions 11 (projecting and receded portions) of the other LED unit 1 interlock. This allows the LED unit 1 to be used as a tool for tightening or loosening another LED unit 1 into or from the lighting fixture 101 when attaching or detaching an LED unit 1 from the lighting fixture 101. In this case, the projecting portions 11 on the two LED units 1 are provided such that the size of the gap in one projecting portion 11 (the distance between two adjacent projections 11a) is wider than the width of the protruding part of the other projecting portion 11 (the width of one of the projections 11a).

Moreover, in the embodiment, two of the projecting portions 11 are provided opposite each other. This makes it possible to hold the LED unit 1 with balance when supporting the two projecting portions 11 with the thumb and the index finger, which in turn makes it possible to hold the LED unit 1 level with further stability.

Moreover, in the embodiment, the distance d11 between adjacent projections 11a in each of the projecting portions 11 is preferably no less than 1 mm and no more than 3 mm. Since this makes it possible for the pad of one finger (an average sized finger) to touch two adjacent projections 11a, the holding stability aspect of the LED unit 1 increases.

Moreover, in the embodiment, the tapered portion 10c of the translucent cover 10 is provided with a plurality of the ribs 12 in addition to the plurality of projecting portions 11. With this, it is possible to place a finger other than the thumb and index finger (such as the middle finger) on the ribs 12. As such, since the LED unit 1 can be supported using three fingers, the LED unit 1 can be held level even more stably. Furthermore, when the LED unit 1 is rotated, since it is possible to catch a finger on the ribs 12 in addition to the projections 11a, the LED unit 1 can be turned even more easily. This in turn makes it even easier to attach and install the LED unit 1 to the lighting fixture 101.

It should be noted that the distance d12 between two adjacent ribs 12 is preferably no less than 1 mm and no more than 3 mm, like the projections 11a. Moreover, the taper width W of the tapered portion 10c ((b) in FIG. 3) is, in consideration of exterior appearance and handleability when turning the LED unit 1, preferably approximately 8 mm.

Moreover, as the above illustrates, the ribs 12 according to the embodiment are formed on the side surface portion 10b of the translucent cover 10 as well. This makes it possible to place fingers other than those on the projecting portions 11 (such as the middle finger) on the side surface portion 10b in case there is just enough of a gap for a finger to enter between the reflection plate 110 of the lighting fixture 101 and the LED unit 1. This allows for the LED unit 1 to be held level even more stably and turned even more easily.

It should be noted that in the embodiment, the ribs 12 on the side surface portion 10b are formed up to 1 mm below the top edge of the side surface portion 10b. In this way, by forming the ribs 12 to have a length of at least 1 mm on the side surface portion 10b, the holdability and rotatability of the LED unit 1 can be improved.

### (Variation 1)

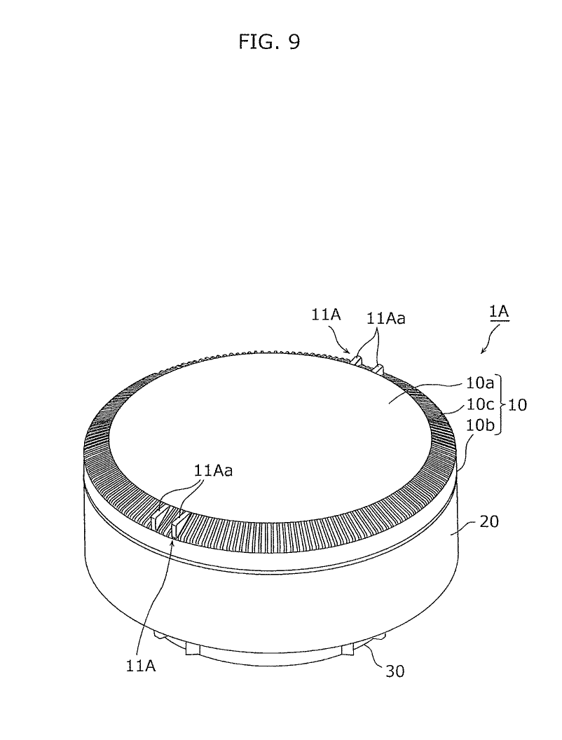

Next an LED unit 1A according to Variation 1 of the present invention will be described using FIG. 9. FIG. 9 is an external perspective view of the LED unit according to Variation 1 of the present invention.

The LED unit 1A according to Variation 1 differs from the LED unit 1 according to the embodiment in regard to the configuration of the projections in the projecting portions.

More specifically, with the LED unit 1 according to the above embodiment, the ridge line of the projections 11a in the projecting portions 11 is inclined with respect to the flat surface portion 10a, but as FIG. 9 shows, with the LED unit 1A according to Variation 1, the ridge line of projections 11Aa in projecting portions 11 is flush with the outer surface of the flat surface portion 10a. In other words, the ridge lines of the projections 11Aa are positioned in the same plane as the outer surface of the flat surface portion 10a.

By having this kind of configuration, the surface area of the flat surface of the plate shaped projections 11Aa provided on the tapered portion 10c can be made to be greater than the surface area of the flat surface S1 of the projections 11a shown in FIG. 3. This makes it even easier to apply force in the rotational direction since it is easier to catch a finger on the projections 11Aa when rotating the LED unit 1A.

### (Variation 2)

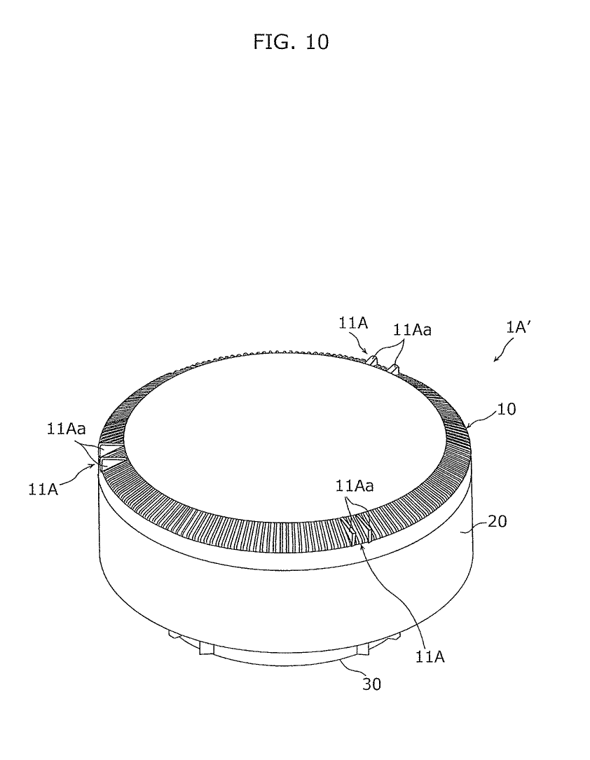

Next an LED unit 1A′ according to Variation 2 of the present invention will be described using FIG. 10. FIG. 10 is an external perspective view of the LED unit according to Variation 2 of the present invention.

The LED unit 1A′ according to Variation 2 is different from the LED unit 1A according to Variation 1 in regard to the number of projecting portions provided.

More specifically, the LED unit 1A according to Variation 1 is provided with two projecting portions 11A positioned opposite each other, while the LED unit 1A′ according to Variation 2 is provided with three projecting portions 11A positioned at approximately equal intervals from each other in the rotational direction R around the lamp axis J. In other words, three projecting portions 11A are provided at roughly 120° intervals around the lamp axis J.

With this kind of configuration, it is possible to attach the LED unit 1A′ to the lighting fixture 101 using three projecting portions 11A.

For example, when holding the LED unit 1A′ by hand, it is possible to support the LED unit 1A′ by placing the thumb, index, and middle fingers on the projecting portions 11A. With this, the LED unit 1A′ can be held even more stably.

Moreover, when rotating the LED unit 1A′, it is possible for the thumb, index, and middle fingers to catch on the projections 11Aa. Since this makes it possible to apply even more force in the rotational direction R, the connecting pins 80 can be easily pushed into the spring components 121a.

It should be noted that the modifications in Variation 2 can be applied to Variation 1. In other words, the LED unit 1 according to Variation 1 may be provided with the projecting portions 11 at three locations. In this case, the three projecting portions 11 can be provided at roughly 120° intervals around the lamp axis J. Moreover, taking into consideration holdability when attaching the LED unit 1 to the lighting fixture, the three projecting portions 11 provided at 120° intervals may be positioned within a ±20° range based on the 120° interval positions.

### (Other Variations)

Hereinbefore, the illumination light source and the lighting apparatus according to the present invention were described based on the embodiment and variations thereof, but the present invention is not limited to the above embodiment and variations thereof.

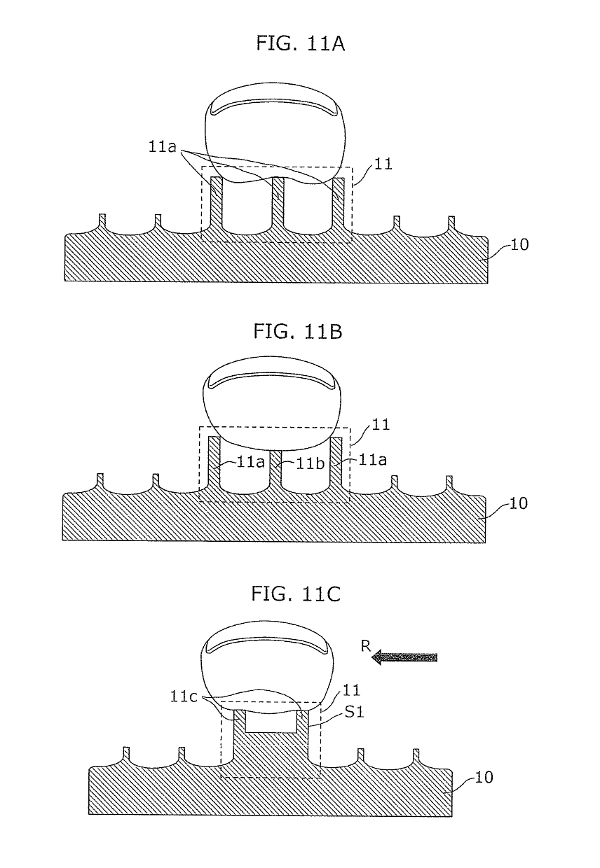

For example, in the above embodiment and variations, each projecting portion is provided with two projections, but the present invention is not limited to this example. More specifically, as FIG. 11A shows, one projecting portion 11 may three include projections 11a. In this case, the three projections 11a are spaced to allow a finger to contact all three of the projections 11a. With this, the LED unit 1 can be held even more stably than the example depicted in FIG. 8. It should be noted that, as FIG. 11A shows, the distance between the two outer projections 11a may be adjusted so that a finger fits adequately therebetween.

Furthermore, as FIG. 11B shows, the height of the middle projection 11b of the three projections may be configured to be shorter than the height of the two outer projections 11a. In this case, the height of the middle projection 11b may be a height which allows it to come into contact with the pad of a finger when a finger is placed on the projecting portion 11. With this, the LED unit 1 can be held even more stably than the example depicted in FIG. 11A.

As long as the projecting portion includes a plurality of projections and includes a flat surface facing a direction opposite the rotational direction R, it is not limited to the configuration of the projecting portions 11 in the embodiment. For example, as FIG. 11C shows, the projecting portions 11 may each be a ridge portion including two projections 11c in the upper region and the flat surface S1 facing a direction opposite the rotational direction R. In other words, the projecting portions 11 may include the flat surface S1 while also including a recessed portion (the region between the projections 11c).

Moreover, in the above embodiment and variations, the LED module 40 is configured as a COB LED module in which LED chips are directly mounted on the substrate 41, but the present invention is not limited to this example. For example, a package type LED element (surface mount device (SMD)) may be used in which an LED chip (light-emitting element) is mounted in a cavity in a resin container and the cavity is sealed with a sealing component (phosphor-containing resin), and a SMD LED module configured to include a plurality of these LED elements mounted on the substrate 41 may be used.

Moreover, in the above embodiment and variations, the LED module 40 is configured to radiate white light using a blue LED chip and a yellow phosphor, but the present invention is not limited to this example. For example, in order to increase color rendering properties, in addition to the yellow phosphor, a red phosphor or a green phosphor may be mixed in. Moreover, a configuration is possible in which, without using a yellow phosphor, a phosphor-containing resin which includes red and green phosphors is used and white light is radiated when used in combination with a blue LED chip.

Moreover, in the above embodiment and variations, the LED chip may be configured using an LED chip which emits light of a color other than blue. For example, when an LED chip which emits ultra-violet rays is used, a combination of phosphor particles which respectively emit the three primary colors (red, green and blue) may be used. Furthermore, wavelength converting materials other than phosphor particles may be used. For example, materials including a substance which absorbs a certain wavelength of light and emits light of a different wavelength, such as semiconductors, metal complexes, organic dyes, and pigments, may be used.

Moreover, in the above embodiment and variations, the light-emitting element is exemplified by an LED, but a semiconductor light-emitting element such as a semiconductor laser, an electro luminescence (EL) element such as an organic EL element or an inorganic EL element, or other solid-state light-emitting elements may be used.

Although only an exemplary embodiment of the present invention and variations thereof have been described in detail above, those skilled in the art will readily appreciate that many modifications are possible in the exemplary embodiment and variations thereof without materially departing from the novel teachings and advantages of the present invention. Accordingly, all such modifications are intended to be included within the scope of the present invention.

### INDUSTRIAL APPLICABILITY

The present invention is applicable as a illumination light source such as a low profile LED unit (LED lamp) having, for example, a GX53 or GH76p base, and can be widely used in lighting apparatuses and such.

1. An illumination light source which attaches to a lighting fixture by being rotated in a predetermined rotational direction, the illumination light source comprising:
a light-emitting unit;
a case which includes an opening and houses the light-emitting unit; and
a translucent cover provided over the opening,
wherein the translucent cover includes a plurality of projecting portions provided at predetermined intervals in the rotational direction, and
the plurality of projecting portions each include a plurality of projections provided at a predetermined distance from each other in the rotational direction and including a flat surface facing a direction opposite the rotational direction.

2. The illumination light source according to claim 1,
wherein the plurality of projecting portions are provided at approximately equal intervals.

3. The illumination light source according to claim 2,
wherein a total number of the plurality of projecting portions is two.

4. The illumination light source according to claim 2,
wherein a total number of the plurality of projecting portions is three.

5. The illumination light source according to claim 1,
wherein each of the plurality of projections is a flat plate having two main surfaces on opposite sides thereof, one of the two main surfaces being the flat surface.

6. The illumination light source according to claim 1,
wherein the predetermined distance is no less than 1 mm and no more than 3 mm.

7. The illumination light source according to claim 1,
wherein the translucent cover includes a flat surface portion whose normal line corresponds to a rotational axis of the illumination light source, a side surface portion provided around the flat surface portion, and a tapered portion provided between the flat surface portion and the side surface portion,
the plurality of projecting portions are provided on the tapered portion, and
a plurality of ribs are provided on the tapered portion between the plurality of projecting portions.

8. The illumination light source according to claim 7,
wherein the plurality of ribs are also formed on the side surface portion.

9. The illumination light source according to claim 7,
wherein the plurality of projections have a ridge line in a radial direction of rotation which is inclined toward the side surface portion with respect to the flat surface portion.

10. A lighting apparatus comprising:
the illumination light source according to claim 1; and
the lighting fixture with the illumination light source attached thereto.
